(19) United States
(12) Patent Application Publication
(10) Pub. No.: US 2005/0174352 A1
(43) Pub. Date: Aug. 11, 2005

(54) Image processing method and system to increase perceived visual output quality in cases of lack of image data

(76) Inventors: Maria Gabrani, Gattikon (CH); Christian Hentschel, Eindhoven (NL); Elisabeth Francisca Maria Steffens, Eindhoven (NL); Reinder Jaap Bril, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/502,182

(22) PCT Filed: Dec. 16, 2002
(86) PCT No.: PCT/IB02/05505

(30) Foreign Application Priority Data
Jan. 23, 2002 (EP) 02075281.2

(51) Int. Cl. G06T 1/00

(52) U.S. Cl. 345/501

(57) ABSTRACT

A digital video processing system is disclosed in which processing modules use less data packets than in the regular situation in which there enough data is received. In case of a channel change, the digital video processing system can, during a time period in which there is a lack of data, produce more images than the prior art systems. These images have lower quality than the ones that result from regular processing, but a person will perceive the image quality to be higher than the one of the prior art.

### FIELD OF THE INVENTION

The present invention relates to a digital video processing system comprising receiving means for receiving a first sequence of data packets before an interrupt and a second sequence of data packets after said interrupt, processing means for processing respectively said first and second sequence of data packets to form consecutive image signals, each consecutive image signal being produced by processing a predetermined number of said first and second sequence of data packets, said processing means being arranged to form substitute consecutive image signals upon said interrupt. The present invention also relates to a video processing method for driving such a system.

### PRIOR ART

Consumer multimedia terminal systems, e.g. Digital TV and Set-top Box, can consist of a number of processing paths between the input (receiver front-end) and the output (display, storage device). Each path is distinguished in a number of processing blocks, e.g. channel decoding and video enhancing. Some blocks are considered to remain in hardware (e.g. channel decoding) while others are opting to be implemented in software (e.g. source decoding).

In interlaced video systems, two consecutive fields with odd respectively even lines belong to one frame. In some applications frames are processed, while in other applications fields are processed. The choice of the term “field” or “frame” processing is however not relevant for this invention. Below, both “fields” or “frames” will be referred to as frames.

For economic reasons, input signals for digital image processing systems, like MPEG, consist of frames with different content. Not every frame contains the whole image. So-called I-frames contain information of the whole image, and are present on regular bases. Frames following an I-frame only contain information on relative changes in the image. From an I-frame and information on relative changes, P-frames and B-frames can be predicted. During a channel change in a Digital TV, an MPEG video decoder has to wait for a first Sequence Header in an I-frame to arrive. The Sequence-Header indicates the start of a new sequence of frames in the new channel. The Sequence-Header shows up only on a regular basis. So after a channel change, there is a time period in which there is a lack of data for the image processing system. At present, there is a delay of up to one second. However, in a consumer terminal, there are hard deadlines and every field/frame period (50/60/100 Hz) a new field/frame should be ready for display. Currently, during a channel change, a black image is displayed until the first Sequence-Header of the new data arrives and new data are processed and ready for display. The black image between two consecutive channels decreases the perceived output quality.

In U.S. Pat. No. 5,933,192, a method is described to avoid a black screen during a channel change by using a multi-channel video receiver that receives the current channel and a most likely next channel. The prediction for the most likely next channel is made by investigating the scrolling behaviour of the user. This solution only works when the user is scrolling through the channels in a predictable way. If the predicted channel is not actually selected by the user, a black image still appears.

It is an object of the present invention to increase the perceived image quality during channel changes or in general video stream changes in digital video processing devices.

### SUMMARY OF THE INVENTION

The invention relates to a digital video processing system comprising receiving means for receiving a first sequence of data packets before an interrupt and a second sequence of data packets after said interrupt, processing means for processing respectively said first and second sequence of data packets to form consecutive image signals, each consecutive image signal being produced by processing a predetermined number of said first and second sequence of data packets, said processing means being arranged to form substitute consecutive image signals upon said interrupt, characterized in that said processing means are arranged to alter their processing after said interrupt using less data packets than said predetermined number of data packets in order to form said substitute consecutive image signals.

A system according to the invention improves the perceived image quality during channel changes or in general video stream changes.

The invention also relates to a video processing method comprising the steps of:
receiving a first sequence of data packets before an interrupt and a second sequence of data packets after said interrupt;
processing said first and second sequence of data packets;
forming consecutive image signals, each consecutive image signal being produced by processing a predetermined number of said first and second sequence of data packets;
forming substitute consecutive image signals upon said interrupt, characterized in that said substitute consecutive image signals are formed using less data packets than said predetermined number of data packets.

### BRIEF DESCRIPTION OF THE DRAWINGS

Below, the invention will be explained with reference to some drawings, which are intended for illustration purposes only and not to limit the scope of protection as defined in the accompanying claims.

FIG. 1 shows a block diagram representing a video processing path from the state of the art.

FIG. 2 shows block diagram representing two parallel video processing paths from the state of the art.

FIG. 3 graphically shows the image quality during a transition period with a freezed image.

FIG. 4 graphically shows the image quality during a transition period with an exploitation of stored image data.

FIG. 5 graphically shows the image quality during a transition period with an exploitation of stored image data and alternative processing.

FIG. 6 graphically shows the image quality during a transition period when using a device with two processing paths with the first processing path producing images until the second path is ready to deliver a new image.

### DESCRIPTION OF PREFERRED EMBODIMENTS

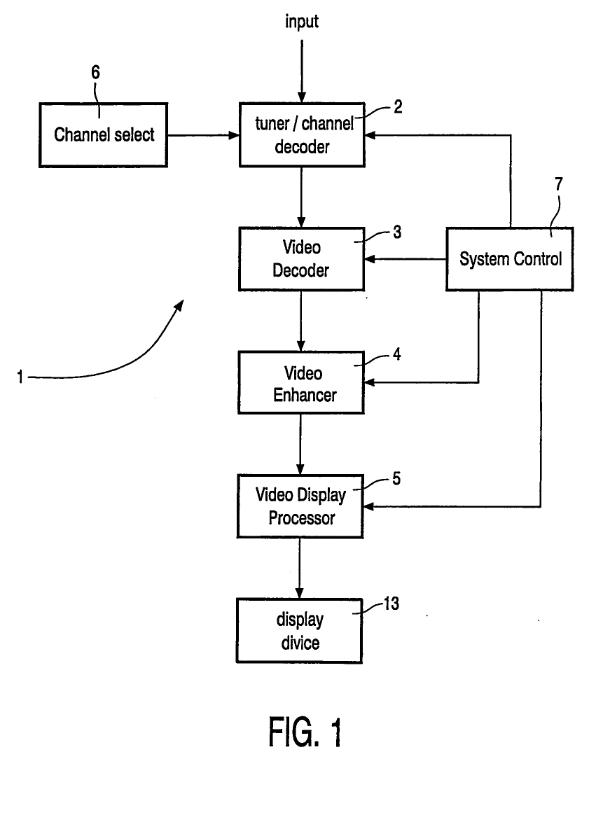

FIG. 1 shows a block diagram of a possible video processing system 1 with one processing path as can be found in a state of the art consumer multimedia system. The video processing path consists of a number of processing blocks. An input signal, e.g. a broadcast signal, is input for a tuner/channel decoder 2. The output of the tuner/channel decoder 2 is input for a video decoder 3 which comprises a sequence header detector, not shown in the figure, for the detection of a Sequence Header. Not shown is a demultiplexer for separation of video and audio information and an audio decoder. The output of the video decoder is input for a video enhancer 4. Data coming from the video enhancer 4 is input for a video display processor 5. The output of the video display processor 5 is a video signal that can be displayed by an appropriate display device 13 e.g. a monitor of a Digital TV. The tuner/channel decoder 2 is connected to a channel select unit 6. This channel select unit 6 is operated by a user in order to select a certain broadcast channel. A system control unit 7 is present to communicate with the tuner/channel decoder 2, the video decoder 3, the video enhancer 4 and the video display processor 5. All components can be implemented in both software and hardware.

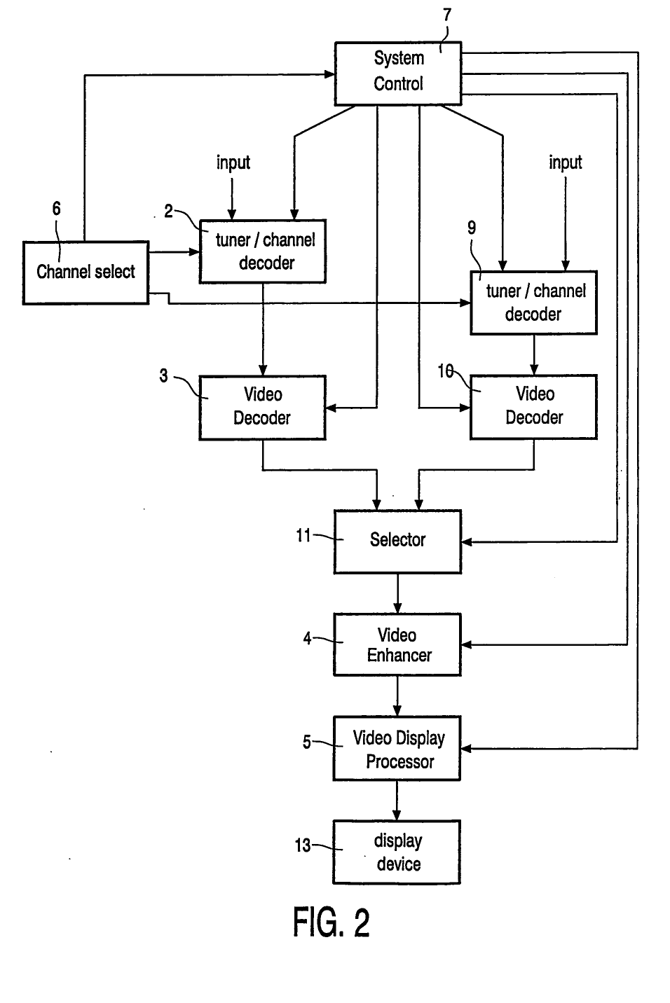

In FIG. 2 a block diagram is shown representing an example of a video processing system 8 with two processing paths. A first path is similar to the video processing path shown in FIG. 1 but with an additional selector 11. A second path consists of a tuner/channel decoder 9, a video decoder 10, and the selector 11 and the already mentioned video enhancer 4 and video display processor 5.

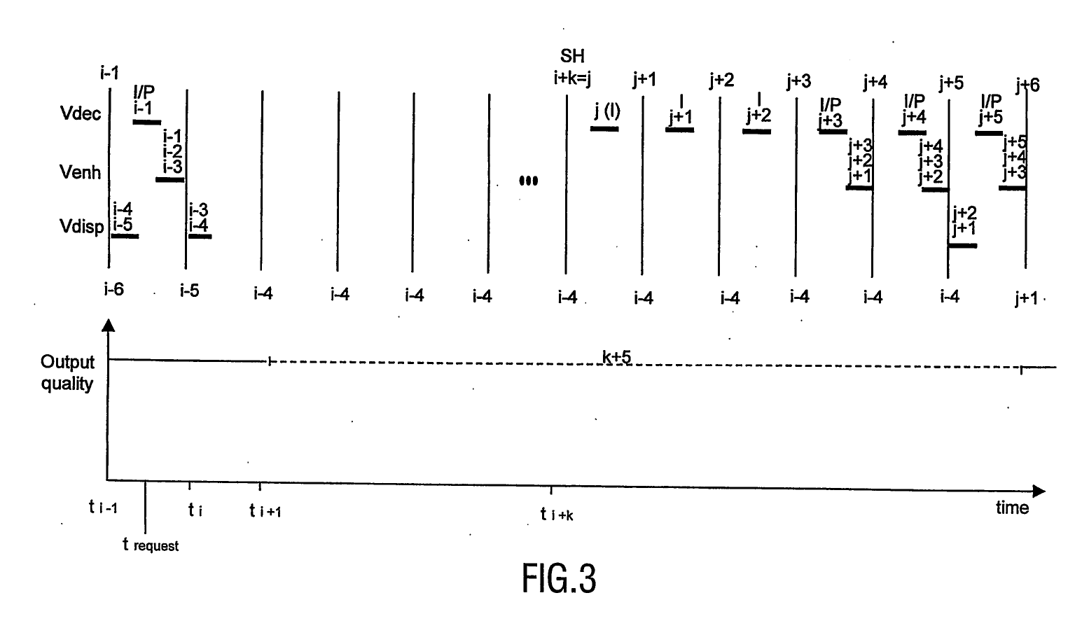

In FIG. 3 an example of a transition period from a channel change between two digital channels is described. In this example, it is assumed that the video processing system 1 only contains a single processing path, e.g., modules 2, 3, 4, 5 shown in FIG. 1. The modules that consume processing time are the video decoder 3, the video enhancer 4 and the video display processor 5. In FIG. 3, the vertical lines indicate the start of consecutive frame periods of an incoming digital video signal. Each processing step of the modules 3, 4, 5 is depicted as a small horizontal bar. In every frame period the top bar, indicated by Vdec at the left, corresponds to the processing time of the video decoder 3. The middle bar Venh corresponds to the processing time of the video enhancer 4. The bottom bar Vdisp corresponds to the processing time of the video display processor 5. Data packets that are used for a certain processing step, are depicted as indexes just above the corresponding bar. It is observed that the term “data packet” is used here in a broad sense. It relates to a portion of video data of a predetermined size, like for example one field. In one processing step more than one of such portions may be processed, as will be illustrated hereinafter.

Video decoder 3 stores information on I and P frames in order to process incoming data. A P-frame is predicted from an I-frame. The order of incoming I and P-frames is not defined, so in FIG. 3 “I/P” depicts an I- or a P-frame. The indexes (e.g. i-1) on top of the vertical lines indicate the relative frame number (index) of the input packet in the processing path. The indexes (e.g. i-5) at the bottom of the vertical lines indicate the number of the displayed image.

Every module 3, 4, 5 has been given (different) priorities. The highest priority is given to the video display processor 5. This is because every new frame period, an output image is needed. The second highest priority is given to the video decoder 3, and the lowest priority is given to the video enhancer 4, since this is the less critical component.

At time t=tᵢ₋₁ a data packet i-1, belonging to a first channel is input to the processing path. At this time, image i-6 is displayed and the system is working in a steady state mode. In this example the following frame delays are assumed; one for video decoding in the video decoder 3, two for video enhancement in the video enhancer 4, and one for the video display process in video display processor 5. Thus, when data packet i-1 arrives in the system, the video display processor 5 is working on data packet i-5, the video decoder 3 on data packet i-1, and video enhancer 4 on data packet i-3, causing a latency of 4 frame periods.

At a moment t=t_{request} between the receiving of input of packet i-1 and i, a request for changing the channel is encountered. Such a request is generated by the channel select unit 6 as operated by a user and transmitted to the tuner/channel decoder 2. At that moment the video display processor 5 produces image i-5 which is shown on a display device 13. A new frame period starts, and the video display processor 5 works on data packets i-4 and i-3. These data packets were available from the previous frame period. The video decoder 3 is informed by the system control unit 7 (or the channel decoder 2) that a channel change to a second channel has occurred and that it must wait for a Sequence-Header of the second channel. The video enhancer 4 waits for input but does not get one and thus it blocks. In the next frame period, if no Sequence-Header of the second channel has arrived, the video display processor 5 does not get any data in its input queue and thus blocks after having produced the last image i-4. Now the system performs exception handling by displaying the last produced image i-4 and the output/display freezes. After k frame periods, at time t=tᵢ₊ₖ, the Sequence Header from the new channel is received by tuner/channel decoder 2. Now a first data packet j of the new channel is input for the processing path. This first data packet j contains an I-frame which is indicated by j(I). Next, the video decoder 3 processes the new data packet, which is used to decode a P-frame. Both I- and P-frames are needed to predict a B-frame in between. Therefore, the decoder does not output the first decoded I-frame immediately, to accomplish a continuous stream in a steady state. At t=tᵢ₊ₖ₊₁ (i.e. t=tⱼ₊₁ with j=i+k) the video decoder 3 outputs the new data packet j+1. The new mode of the video enhancer 4 needs 2 more data packets (i.e. j+2, j+3) before it can provide a new output. After having received data packets j+2 and j+3, the video enhancer 4 produces data packet j+1 for the video display processor 5. At this point, the video display processor 5 waits for one more frame period, to receive data packet j+2 from video enhancer 4, until it outputs the first new data image j+1 at t=tⱼ₊₆.

The above mentioned processing results in a freeze of the displayed image i-4 for k+5 frame periods, as is indicated by the dashed line in the output quality diagram in FIG. 3. In addition, data from 3 frame periods, i.e. i-1, i-2, i-3, of the first channel are thrown away.

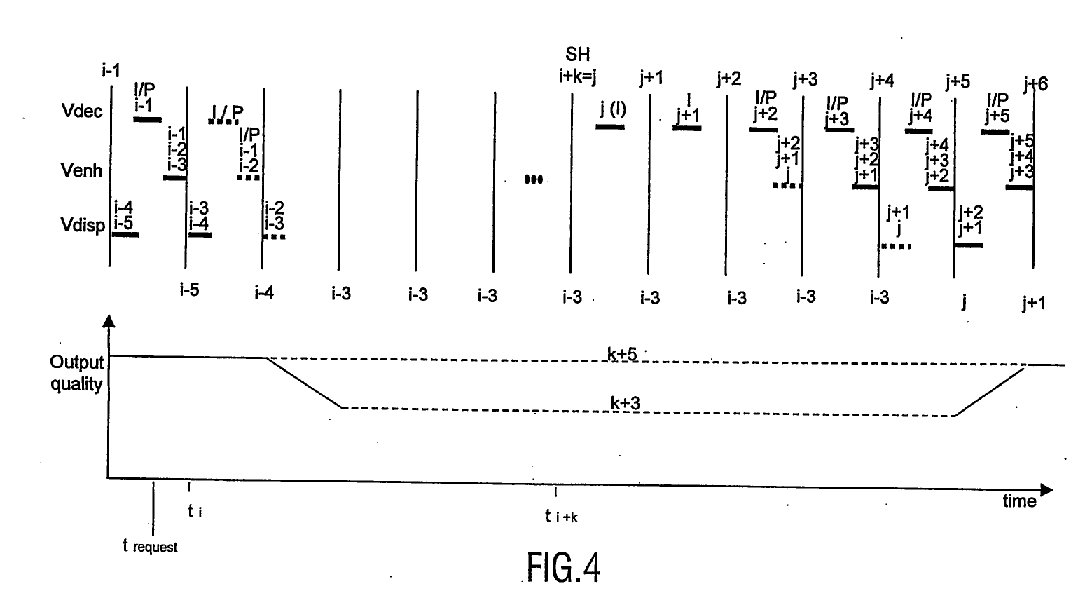

In a first embodiment of the present invention an alternative image processing is used in order to decrease the freeze time mentioned above, see also FIG. 4. The video decoder 3 in a steady state has 2 frames in memory, which assist in the decoding of P or B-frames. Thus, while waiting for a next data packet form the first channel, and before changing to the second channel, the video decoder 3 can output one more frame that is already decoded and kept in memory. This results in one more frame period of regular processing for the video enhancer 4 and the video display processor 5, see dashed bars in FIG. 4. As can be seen in FIG. 4, this processing scheme results in the video display processor 5 being able to produce image i-3 at tᵢ₊₂, whereas (as shown in FIG. 3) in the prior art the last image that could be produced by video display processor 5 was i-4 at tᵢ₊₁.

Preferably similar alternative processing is used for the second channel, which is processed after the new Sequence-Header occurring at t=tᵢ₊ₖ. At time t=tᵢ₊ₖ the video decoder 3 can make a copy of a first I-frame, output it to the video enhancer 4, and at the same time keep it in memory for a next frame to decode. This results in one extra frame period of regular processing since video enhancer 4 has three data packets j, j+1, j+2 already at time tⱼ₊₃, i.e., video enhancer 4 can start processing one frame period earlier than in the prior art as explained in FIG. 3. This is indicated by character j just above the dashed bar in FIG. 4 in the between t=tⱼ₊₂ and t=tⱼ₊₃. In this way the freeze time is again decreased by one frame period. As can be seen in FIG. 4, the total freeze time now is equal to k+3 frame periods, which is two frame periods less than the k+5 frame periods according to the prior art of FIG. 3.

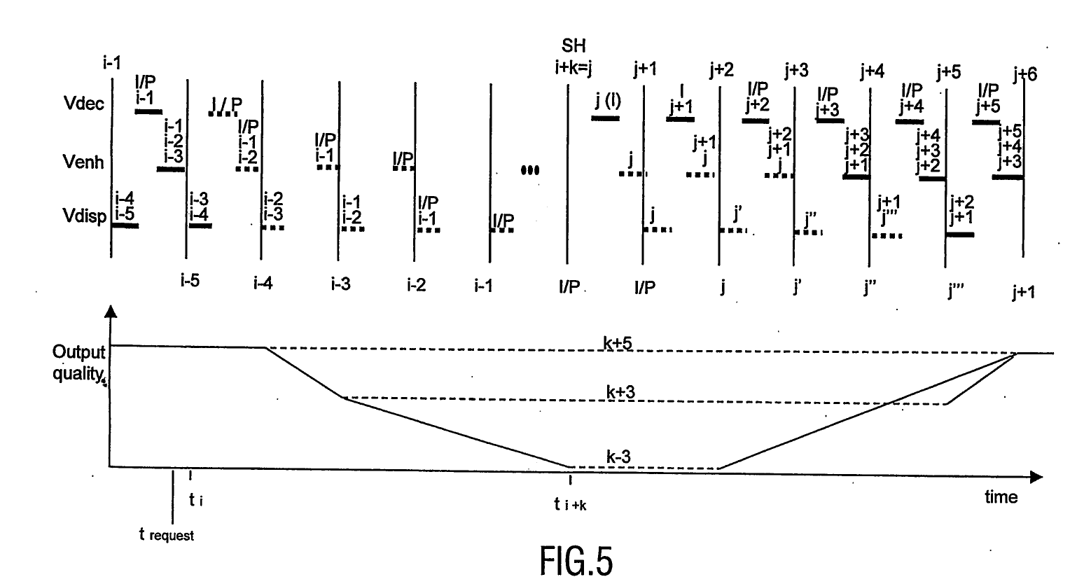

In a second embodiment of the invention the processing in the video decoder 3 occurs as in the first embodiment but in addition the processing within the video enhancer 4 and video display processor 5 is altered gradually. Let's assume that the video enhancer 4 requires three data packets to output the next frame. Since this processing step includes programmable components, it can be altered during processing. The processing of the video enhancer 4 is now altered in such a way that it only needs two data packets, and at the next frame period only, one data packet to continue providing an output. So the video enhancer 4 provides output during two more frame periods. Preferably similar handling is used for the video display processor 5, thus gaining one more frame period, see dashed bars in FIG. 5. So between tᵢ and tᵢ₊₁, video enhancer 4 processes data packets I/P, i-1, and i-2, between tᵢ₊₁ and tᵢ₊₂ it processes data packet I/P and i-1, and between tᵢ₊₂ and tᵢ₊₃ it processes data packet I/P only. Moreover between tᵢ₊₂ and tᵢ₊₃ video display processor 5 is able to process data packets i-1 and i-2, between tᵢ₊₃ and tᵢ₊₄ data packets I/P and i-1, and finally between tᵢ₊₄ and tᵢ₊₅ data packet I/P. This is a total gain of three more processing periods in comparison with FIG. 4. The output now freezes at time t=tᵢ₊₅.

In another embodiment similar alternative processing is done for the processing of the second channel as soon as the Sequence Header is received at tⱼ. Instead of waiting for two more data packets, the video enhancer 4 can already work on one data packet and provide an output of lower quality. Similar alternative processing is done in the video display processor 5. This results in a low quality output image j at time t=tⱼ₊₂. The resulting total freeze period is then equal to k-3 frame periods, see bottom output quality line in FIG. 5.

In yet another embodiment a video processing system 8 includes two processing paths, e.g. 2-3-11-4-5 and 9-10-11-4-5, as shown in FIG. 2. This means that two different channels can be received and processed in parallel from either the same input or different inputs. Selector 11 selects one of the outputs of the video decoders 3, 10 and feeds this stream to the video enhancer 4.

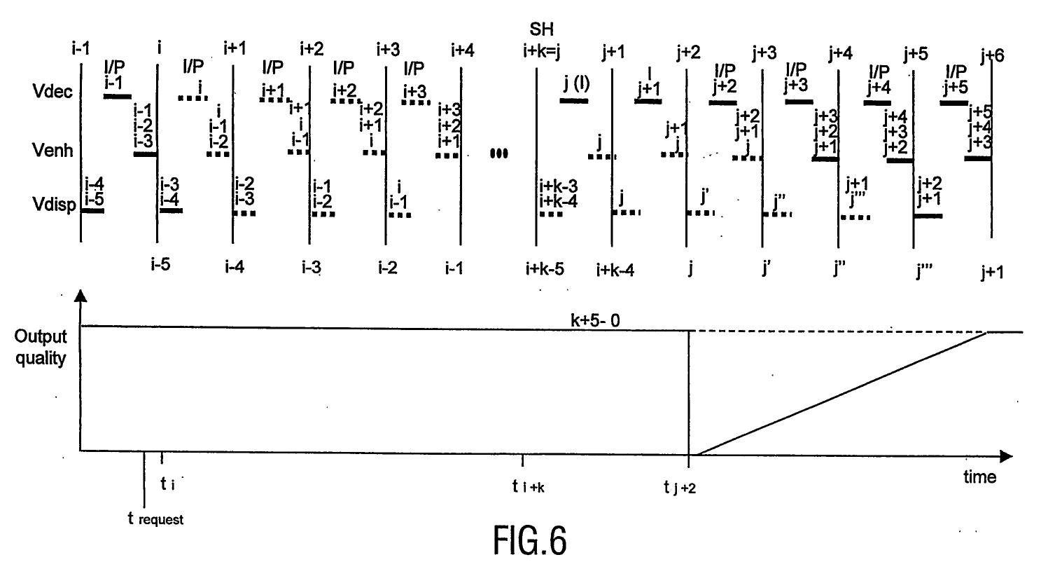

As video decoder 3, video decoder 10 also comprises a sequence-header detector, not shown. After the new Sequence-Header has appeared at t=tᵢ₊ₖ the second processing path needs two more frame periods before it can produce the first image, see t=tⱼ₊₂ in FIG. 6. Until t=tⱼ₊₂ regular processing is done on the first channel in the first path 2-3-11-4-5, resulting in high quality images. Thereafter, the second processing path takes over and a soft quality increase of the second channel starts, as indicated by the upgoing slope in FIG. 6. It is noted that this slope is actually staircase like, but for the sake of simplicity a slope is used.

Since two channels are processed in parallel, transition time can completely be avoided by processing and displaying the first channel until the second channel is processed in a regular high quality way. However, a user, after having pressed a button, will have to wait a while (e.g. one second) before the second channel appears. This may cause annoyance, which can be regarded as low perceived quality. Therefore, in this invention the second channel is shown as soon as possible, even if this means lower quality at the start.

The proposed systems are described for the case of channel changing. However, the approaches are valid for any case that may cause lack of data in the input of an algorithm and where a lower quality image is better than a freezed image. Examples of such cases are:
The switch between movie and commercials being encoded with different encoder than the movie.
Switching between two decoder paths, with either MPEG-decoding, other video streams or mixed MPEG and video streams.
TiVo like applications allow users to watch the contents of the same broadcasted channel but shifted in time by reading the data from a local storing device. The data in the storing device are transcoded and thus encoded in a different format than initially by the broadcaster.

While the invention has been described in connection with preferred embodiments, it will be understood that modifications thereof within the principles outlined above will be evident to those skilled in the art. For example in FIG. 2 and 3, the system control 7 is depicted as one block however the system control may not be the same for the entire processing paths. In an embodiment of the invention the video display processor 5 is a separate unit with a separate system control.

The invention is not limited to the preferred embodiments but is intended to encompass such modifications.

1. A digital video processing system (1) comprising receiving means (2; 2, 9), for receiving a first sequence of data packets before an interrupt and a second sequence of data packets after said interrupt, processing means (3, 4, 5; 3, 4, 5, 10) for processing respectively said first and second sequence of data packets to form consecutive image signals, each consecutive image signal being produced by processing a predetermined number of said first and second sequence of data packets, said processing means (3, 4, 5; 3, 4, 5, 10) being arranged to form substitute consecutive image signals upon said interrupt, characterized in that said processing means (3, 4, 5; 3, 4, 5, 10) are arranged to alter their processing after said interrupt using less data packets than said predetermined number of data packets in order to form said substitute consecutive image signals.

2. A digital video processing system (1) according to claim 1, characterized in that said processing means (3, 4, 5; 3, 4, 5, 10) are arranged to, during consecutive processing periods, use gradually less data packets when processing said first sequence of data packets to form said substitute consecutive image signals.

3. A digital video processing system (1) according to claim 2, characterized in that said substitute consecutive image signals are identical during consecutive processing periods after a moment when said processing means (3, 4, 5; 3, 4, 5, 10) do not receive any new data packets to process.

4. A digital video processing system (1) according to claim 1, characterized in that said processing means (3, 4, 5; 3, 4, 5, 10) are arranged to, during consecutive processing periods, use gradually more data packets when processing said second sequence of data packets to form said substitute consecutive image signals.

5. A digital video processing system (1) according to claim 1, characterized in that said digital video processing system (1) comprises a first processing path comprising first receiving means (2) for receiving said first sequence of data packets, first processing means (3, 4, 5) for processing said first sequence of data packets, and a second processing path comprising second receiving means (9) for receiving said second sequence of data packets, second processing means (4, 5, 10) for processing said second sequence of data packets.

6. A digital video processing system (1) according to claim 5, characterized in that said second processing means (4, 5, 10) are arranged to, during consecutive processing periods, use gradually more data packets when processing said second sequence of data packets to form said substitute consecutive image signals, and in that said first processing means (3, 4, 5) are arranged to process using said predetermined number of data packets, to form said substitute consecutive image signals until said second processing means (4, 5, 10) have formed an image signal out of the second sequence of data packets.

7. A video processing method comprising the steps of:
receiving a first sequence of data packets before an interrupt and a second sequence of data packets after said interrupt;
processing said first and second sequence of data packets;
forming consecutive image signals, each consecutive image signal being produced by processing a predetermined number of said first and second sequence of data packets;
forming substitute consecutive image signals upon said interrupt, characterized in that said substitute consecutive image signals are formed using less data packets than said predetermined number of data packets.
